(19) United States
(12) Patent Application Publication
(10) Pub. No.: US 2026/0246852 A1
(43) Pub. Date: Aug. 20, 2026

(54) Cloud Desktop System, Network Redirection Method, Device, and Storage Medium

(71) Applicant: CLOUD INTELLIGENCE ASSETS HOLDING (SINGAPORE) PRIVATE LIMITED, Singapore (SG)

(72) Inventor: Jian PI, Shenzhen, Guangdong (CN)

(21) Appl. No.: 18/876,606

(22) PCT Filed: Jun. 21, 2023
(86) PCT No.: PCT/CN2023/101963

§ 371 Date: Dec. 18, 2024

(30) Foreign Application Priority Data
Jun. 23, 2022 (CN) 202210726297.4

(51) Int. Cl. H04L 67/563; H04L 67/12

(52) U.S. Cl. CPC H04L 67/563; H04L 67/12

(57) ABSTRACT

The embodiments of present disclosure provide a cloud desktop system, a network redirection method, a device, and a storage medium. In the embodiments of present disclosure, a network redirection channel between a cloud desktop server and a terminal is established based on a cloud desktop transmission protocol, through the network redirection channel between the cloud desktop server and the terminal, a network request sent by the cloud desktop server is redirected to the terminal, and the terminal accesses a destination address of the network request, achieving network redirection for the network request of the cloud desktop server. Compared with traditional network redirection schemes, the network redirection method provided by the embodiments of present disclosure can eliminate the need for dedicated network configuration, which contributes to enhancing the efficiency of network redirection, and reducing the usage threshold and network redirection cost associated with cloud desktops.

The present disclosure claims priority of Chinese Patent Application No. 202210726297.4, filed to China Patent Office on Jun. 23, 2022 and titled “Cloud Desktop System, Network Redirection Method, Device, and Storage Medium”, the content of which is hereby incorporated by reference in its entirety.

### TECHNICAL FIELD

The present disclosure relates to the field of cloud service technology, particularly to a cloud desktop system, a network redirection method, a device, and a storage medium.

### BACKGROUND OF THE INVENTION

A cloud desktop implements the virtualization technology on computer hardware resources, so that the computer hardware resources are virtualized into multiple virtual computers, on which desktop operating systems run directly without any modification. At the same time, the cloud desktop further provides an operating system supporting virtualization technology, and virtualized applications runs directly on this desktop operating system.

The cloud desktop is an end-side product, and in many cases, it is necessary to transfer network traffic to a terminal side. Therefore, how to implement the network redirection of the cloud desktop has become an urgent technical problem to be resolved in this technical field.

### SUMMARY OF THE INVENTION

At least some embodiments of the present disclosure provide a cloud desktop system, a network redirection method, a device, and a storage medium, achieving network redirection for cloud desktop network requests.

In some embodiments, a cloud desktop system is provided, including: a terminal and a cloud desktop server.

The terminal is arranged for sending a cloud desktop service request to the cloud desktop server.

The cloud desktop server cooperated in conjunction with the terminal, is arranged for, in response to the cloud desktop service request, establishing a network redirection channel between the cloud desktop server and the terminal according to a cloud desktop transmission protocol, the cloud desktop transmission protocol supporting the establishment of the network redirection channel.

The cloud desktop server is further arranged for redirecting a desktop network request of the cloud desktop server to the terminal through the network redirection channel.

The terminal is further arranged for accessing a destination address corresponding to the desktop network request and providing a request result of the desktop network request returned from the destination address to the cloud desktop server through the network redirection channel.

In some embodiments, a network redirection method is further provided, which includes that: in response to a cloud desktop service request of a terminal, a network redirection channel is established between a cloud desktop server and the terminal according to a cloud desktop transmission protocol;
a desktop network request of the cloud desktop server is redirected to the terminal through the network redirection channel for the terminal to access a destination address corresponding to the desktop network request;
a request result of the desktop network request returned by the terminal is obtained through the network redirection channel.

In some embodiments, a network redirection method is further provided, which includes that:
in response to a cloud desktop service request of a terminal, a network redirection channel is established between the terminal and a cloud desktop server according to a cloud desktop transmission protocol;
a desktop network request is obtained and the desktop network request is redirected by the cloud desktop server to the terminal through the network redirection channel; a destination address corresponding to the desktop network request is accessed according to the desktop network request;
a request result returned, in response to the desktop network request, from the destination address is obtained;
the request result is provided to the cloud desktop server through the network redirection channel, providing for the cloud desktop service to process the request result.

In some embodiments, a computing device is further provided, which includes: a memory, a processor, and a communication component; wherein, the memory is arranged for storing a computer program.

The processor is coupled with the memory and the communication component, and the processor is arranged for executing the computer program to perform the steps in the aforementioned network redirection method.

In some embodiments, a computer-readable storage medium storing computer instructions is further provided, when the computer instructions are executed by at least one processor, the at least one processor is arranged for performing the steps in the aforementioned network redirection method.

Through the embodiments of the present disclosure, the network redirection channel between the cloud desktop server and the terminal is established based on the cloud desktop transmission protocol, through the network redirection channel between the cloud desktop server and the terminal, the network request sent by the cloud desktop server is redirected to the terminal, and the terminal accesses the destination address of the network request, achieving network redirection for the network request of the cloud desktop server. Compared with traditional network redirection schemes, the network redirection method provided by the embodiments of present disclosure can eliminate the need for dedicated network configuration, which contributes to enhancing the efficiency of network redirection, and reducing the usage threshold and network redirection cost associated with cloud desktops.

### BRIEF DESCRIPTION OF DRAWINGS

The drawings described here are used for providing a further understanding of present disclosure and forming a part of present disclosure. The illustrative embodiments and descriptions of these illustrative embodiments in present disclosure are used for explaining present disclosure and do not constitute an undue limitation on present disclosure. In the drawings:

FIG. 1 is a structural schematic diagram of a traditional cloud desktop system;

FIG. 2 is a structural schematic diagram of a cloud desktop system provided in some embodiments of present disclosure;

FIG. 3 is a schematic diagram of a network redirection process in the cloud desktop system provided in some embodiments of present disclosure;

FIG. 4 and FIG. 5 are flow schematic diagrams of network redirection methods provided in some embodiments of present disclosure;

FIG. 6 is a structural schematic diagram of a computing device provided in some embodiments of present disclosure.

### DETAILED DESCRIPTION OF THE INVENTION

To make the purposes, technical solutions, and advantages of present disclosure clearer, the following will provide a clear and complete description of the technical solutions of present disclosure in conjunction with specific embodiments and corresponding drawings. Obviously, the described embodiments are part of the embodiments of present disclosure, not all of the embodiments of present disclosure. Based on the embodiments in the present disclosure, all other embodiments obtained by those skilled person in the art without creative labor are within the scope of protection of the present disclosure.

In some embodiments of the present disclosure, a cloud desktop implements the virtualization technology on computer hardware resources, so that the computer hardware resources are virtualized into multiple virtual computers, on which desktop operating systems run directly without any modification. At the same time, the cloud desktop can further provide an operating system supporting virtualization technology, and virtualized applications can run directly on this desktop operating system.

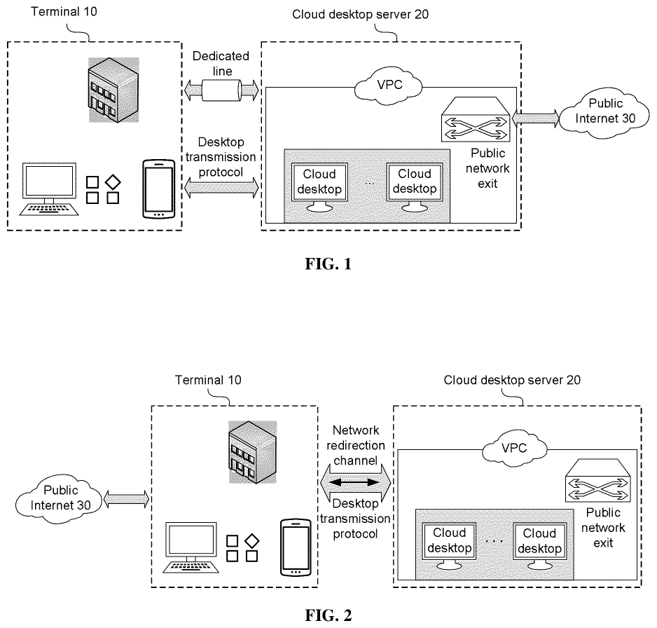

In the traditional cloud desktop solution, as shown in FIG. 1, the cloud desktop system generally includes: a terminal 10 and a cloud desktop server 20. In some embodiments of the present disclosure, the cloud desktop server 20 refers to a server device providing cloud desktop services. The cloud desktop server 20 is a computer device for performing cloud desktop management, and in response to the cloud desktop service request of the terminal 10, providing users with services related to the cloud desktop. The cloud desktop server 20 generally has the ability to undertake services and ensure service capabilities. The cloud desktop services deployed by the cloud desktop server 20 include but are not limited to: cloud desktop, cloud desktop operating system, cloud desktop control services, and cloud desktop protocol services, etc.

The server device is a single server device, a cloud-based server array, or a virtual machine (VM) running in a cloud-based server array. In addition, the server device further refers to other computing devices with corresponding service capabilities, such as computers and other terminal devices (running service programs), etc.

The terminal 10 refers to a device or a software functional module accessing the cloud desktop server 20 through a wireless network, such as a mobile phone, a notebook computer, a tablet computer, a Point of Sale (POS) machine, a thin client, etc. Of course, the terminal 10 is further a soft terminal corresponding to the cloud desktop. For the terminal 10 with a physical device, a thin client (namely a device similar to a TV set-top box) is arranged for connecting with a display, a keyboard and a mouse. The terminal 10 is further arranged for installing a client program corresponding to the cloud desktop, accessing a virtual machine host of the cloud desktop server 20 through a unique communication protocol (such as a desktop transmission protocol, etc.) to achieve interactive operations, and achieve an experience effect consistent with physical terminals (such as computers, etc.). At the same time, the cloud desktop not only supports replacing traditional computers but also supports other mobile devices such as mobile phones and tablets to access the Internet.

In the traditional cloud desktop solution, the terminal 10 requests a cloud desktop service from the cloud desktop server 20. The cloud desktop server 20 accesses the public Internet 30 using the cloud desktop service. For the desktop network request to access the public Internet 30, the cloud desktop server 20 forwards the desktop network request to the public Internet 30 through a public network exit to access the public Internet 30. In some embodiments of the present disclosure, the specific implementation form of the services deployed on the public Internet 30 is not limited. In some embodiments, the services deployed on the public Internet 30 include search engine websites, online shopping websites, instant communication services, or online education websites, etc.

Since the cloud desktop is further an end-side product, in many cases, it is necessary to transfer the network traffic of the cloud desktop server 20 to the terminal 10. For example, in some embodiments, the cloud desktop server 20 needs to access the local network of the terminal 10. Since a local network of the terminal 10 is a private network, the cloud desktop server 20 cannot obtain a public network Internet Protocol (IP) address of the local network of the terminal 10, the cloud desktop server 20 cannot directly access the local network of the terminal 10. For example, in some other embodiments, the cloud desktop server 20 needs to transfer the access traffic to some special dedicated line networks (such as medical systems, medical insurance systems, etc.) to the terminal 10. The cloud desktop is a server-side program, and provides externally a IP segment corresponding to the server. Special dedicated line networks do not support accessing by the IP segment corresponding to the server. Therefore, it is necessary to transfer the network request traffic to the special dedicated line network to the terminal 10 side in the cloud desktop system.

For example, in some other embodiments, for services or websites deployed on the public Internet 30, it is required that an IP address accessing the services or websites on the public Internet 30 with the same user identifier (such as the same account, username, etc.) is the same IP address. However, for the cloud desktop system shown in FIG. 1, an IP address of the terminal 10 of the user and the cloud desktop service called by the terminal 10 is different, resulting in different IP addresses for the same user identifier to access the services or websites on the public Internet 30. For the services or websites on the public Internet 30, the services or websites on the public Internet 30 may block at least one of network access of the terminal 10 of the user and network access of the cloud desktop service called by the terminal 10, resulting in the user being unable to access the services or websites on the public Internet 30.

In some embodiments, for the cloud desktop system, the cloud architecture of the terminal 10 may cause some behavioral control measures on the side of the terminal 10 to fail, and in this case, network data communication between the cloud desktop and the terminal 10 is further required.

In order to achieve network communication between the terminal 10 and cloud desktop server 20, and the desktop network request initiated by the cloud desktop server 20 is redirected to the terminal 10, in some traditional schemes, a network channel is established between the cloud desktop server 20 and the terminal 10 to achieve network communication between the cloud desktop server 20 and the terminal 10. The network channel is generally a Virtual Private Network (VPN), Software Defined Wide Area Network (SDWAN), and dedicated line network, etc. This network redirection scheme connects the desktop with the local Internet Data Center (IDC) network. However, this method of using a dedicated line network channel between the cloud desktop server 20 and the terminal 10 for network redirection is complex in configuration and operation, leading to low efficiency in network penetration between the cloud desktop and the local network, resulting in a long time delay for the terminal 10 to access the public Internet 30 in this network redirection scheme, far higher than an access delay for the actual terminal to the public Internet 30. On the other hand, in the traditional network redirection scheme, the cloud desktop server 20 accesses a fixed local private network.

In view of the shortcomings of the traditional cloud desktop system network redirection scheme, in some embodiments of the present disclosure, a network redirection channel between the cloud desktop server and the terminal is established according to the cloud desktop transmission protocol. Through establishing the network redirection channel between the cloud desktop server and the terminal, the network request initiated by the cloud desktop server is redirected to the terminal, and the terminal accesses the destination address of the network request, achieving network redirection of the network request of the cloud desktop server 20. Since the network redirection channel between the cloud desktop server and the terminal in the present disclosure is established according to the cloud desktop transmission protocol, compared with the traditional network redirection scheme in FIG. 1, there is no need for dedicated network configuration, which helps to improve the efficiency of network redirection and reduce the usage threshold and the cloud desktop cost.

On the other hand, for the network of the destination address, an access to the destination address by the terminal is perceived, and an original source (namely the cloud desktop server) of the desktop network request cannot be perceived. Therefore, even for the destination network that the cloud desktop server cannot access in traditional schemes, the network redirection method provided by some embodiments of the present disclosure can also achieve access to the destination network by redirecting the access of the cloud desktop server to the destination network to the terminal, which can enrich the usage scenarios of the cloud desktop.

The following, in conjunction with the drawings, details the technical solutions provided by each embodiment of present disclosure.

It should be noted that the same reference numbers in the following drawings and embodiments represent the same object, thus once an object is defined in a drawing or embodiment, it does not need to be further discussed in subsequent drawings and embodiments.

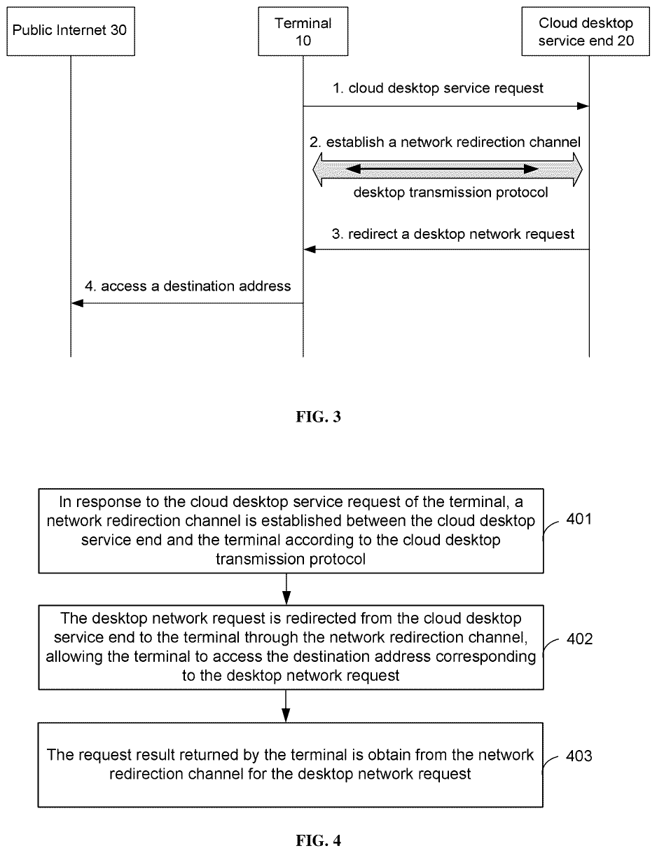

FIG. 2 is a structural schematic diagram of another cloud desktop system provided in some embodiments of the present disclosure. FIG. 3 is a process schematic diagram of the cloud desktop system for network redirection provided in some embodiments of the present disclosure. The descriptions of the terminal 10 and the cloud desktop server 20 can refer to the relevant content of the embodiment in FIG. 1, which is not repeated here.

In some embodiments of the present disclosure, combined with FIG. 2 and FIG. 3, when the terminal 10 requires cloud desktop services, the terminal 10 initiates a cloud desktop service request to the cloud desktop server 20. In order to achieve network redirection of the cloud desktop, the terminal 10 and the cloud desktop server 20 cooperate in conjunction to establish a network redirection channel between the cloud desktop server 20 and the terminal 10 for data transmission between the cloud desktop server 20 and the terminal 10 in response to the cloud desktop service request. The cloud desktop server 20 and the terminal 10 desktop achieves data forwarding through the network redirection channel.

In order to achieve the establishment of a network channel between the cloud desktop server 20 and the terminal 10, the desktop transmission protocol is modified in this embodiment of the present disclosure to make the cloud desktop transmission protocol support to create a network channel. In this embodiment, the cloud desktop transmission protocol refers to the exchange rule for the terminal to connect with the virtual desktop through a network to transmit data. The cloud desktop transmission protocol stipulates a data transmission method between a cloud host and a cloud terminal, and the data transmission method includes security and performance optimization functions such as encryption, encoding and decoding, and network Quality of Service (QoS). In traditional schemes, the cloud desktop transmission protocol establishes a data transmission channel between the cloud desktop server 20 and the terminal 10, and the data transmission channel is used for transmitting data such as screen, sound, and terminal peripheral operations. The terminal peripherals include but are not limited to: keyboards, mice, Universal Serial Bus (USB) interfaces, etc. However, the traditional cloud desktop transmission protocol cannot establish a network channel between the cloud desktop server 20 and the terminal 10. Therefore, in this embodiment of the present disclosure, the cloud desktop transmission protocol is modified to make the desktop transmission protocol support the network channel between the cloud desktop server 20 and the terminal 10. In this embodiment of the present disclosure, the network channel between the cloud desktop server 20 and the terminal 10 is called the network redirection channel.

Based on the above cloud desktop transmission protocol, in response to the cloud desktop service request, the terminal 10 and the cloud desktop server 20 cooperate in conjunction to establish the network redirection channel between the cloud desktop server 20 and the terminal 10 according to the cloud desktop transmission protocol, which achieves network data transmission between the cloud desktop server 20 and the terminal 10.

In this embodiment of the present disclosure, in response to the cloud desktop service request, the terminal 10 initiates a network connection request to the cloud desktop server 20. In response to the network connection request, the cloud desktop server 20 establishes a main channel between the cloud desktop server 20 and the terminal 10. The main channel between the cloud desktop server 20 and the terminal 10 is a Transmission Control Protocol (TCP) connection. The process of establishing a TCP connection main channel between the terminal 10 and the cloud desktop server 20 is implemented as a TCP three-way handshake, which is not further described here.

In this embodiment of the present disclosure, the main channel between the cloud desktop server 20 and the terminal 10 supports various data transmission sub-channels defined by the cloud desktop transmission protocol, including but not limited to: USB channels, video channels, display channels, and network redirection channels. Creation strategy parameters of the sub-channels are the same as creation strategy parameters of the main channel. The cloud desktop transmission protocol provided in this embodiment of the present disclosure has added the data exchange rule for the network redirection channel compared with the traditional cloud desktop transmission protocol. The creation strategy parameters of the sub-channels or the main channel include but are not limited to: image quality information, peripheral redirection strategy and network redirection strategy of the terminal, etc.

In this embodiment of the present disclosure, the terminal 10 obtains the creation strategy parameters of the network redirection channel supported by the cloud desktop transmission protocol. The creation strategy parameters of the network redirection channel are stored in a control service of the cloud desktop server 20. The cloud desktop server 20 deploys cloud desktops, cloud desktop operating systems, cloud desktop control services, and cloud desktop protocol services.

In some embodiments, before the cloud desktop server 20 establishes the network redirection channel between the cloud desktop server 20 and the terminal 10 according to the cloud desktop transmission protocol, the cloud desktop server 20 further authenticates the cloud desktop service request of the terminal 10 according to the cloud desktop service request. Specifically, the control service of the cloud desktop server 20 obtains a user identifier and an access password corresponding to the terminal 10 from the cloud desktop service request. Then, the cloud desktop service request is authenticated according to the user identifier and the access password. For the cloud desktop service request that has passed the authentication, the terminal 10 is allowed to access the cloud desktop server. Correspondingly, when the terminal 10 obtains the creation strategy parameters of the network redirection channel, the terminal 10 obtains the channel creation strategy parameters corresponding to the user of the terminal from the control service of the cloud desktop server 20, and obtains the creation strategy parameters of the network redirection channel from the channel creation strategy parameters.

Further, the terminal 10 initiates a network redirection channel creation request to the cloud desktop server 20 according to the creation strategy parameters of the network redirection channel. Correspondingly, the cloud desktop server 20 establishes a network redirection channel between the cloud desktop server 20 and the terminal 10 in the main channel in response to the network redirection channel creation request. Specifically, the protocol service of the cloud desktop server 20 establishes a network redirection channel between the cloud desktop server 20 and the terminal 10 in the main channel in response to the network redirection channel creation request.

Based on the network redirection channel between the cloud desktop server 20 and the terminal 10, for the desktop network request initiated by the cloud desktop server 20, the cloud desktop server 20 redirects the desktop network request to the terminal 10 through the network redirection channel. Specifically, the cloud desktop server 20 transmits the desktop network request to the terminal 10 through the network redirection channel, achieving the network redirection of desktop network request initiated by the cloud desktop server 20.

In this embodiment of the present disclosure, the network redirection channel between the cloud desktop server 20 and the terminal 10 is available for the transmission of desktop network request. The cloud desktop server 20 is further necessary to have the capability to transmit the desktop network request to the network redirection channel. Correspondingly, the terminal 10 is further necessary to have the capability to receive data from the network redirection channel. Based on this, in this embodiment of the present disclosure, the cloud desktop server 20 further creates a first virtual network card eth_P corresponding to the network redirection channel on the cloud desktop server 20 in response to the cloud desktop service request, to provide an interface for cloud desktop network access. Correspondingly, for the terminal 10, a second virtual network card eth_E corresponding to the network redirection channel is created on the terminal 10, to provide an interface for proxy cloud desktop network access.

Optionally, the cloud desktop server 20 calls virtual network card creation commands in the operating system of the cloud desktop, and executes the virtual network card creation commands to create a virtual network card on the cloud desktop server 20. Further, the created virtual network card is network-configured to make the virtual network correspond to the network redirection channel, thereby obtaining the first virtual network card eth_P corresponding to the network redirection channel.

Similarly, the terminal 10 calls the virtual network card creation commands in the operating system of the terminal, and executes the virtual network card creation commands to create a virtual network card on the terminal 10. Further, the terminal 10 performs network-configuration on the created virtual network card to make the virtual network correspond to the network redirection channel, thereby obtaining the second virtual network card eth_E corresponding to the network redirection channel.

Based on the first virtual network card eth_P on the cloud desktop server 20 and the second virtual network card eth_E on the terminal 10, when the cloud desktop server 20 redirects the desktop network request to the terminal 10 through the network redirection channel, the cloud desktop server 20 sends the desktop network request through the first virtual network card eth_P to the network redirection channel, thereby transmitting the desktop network request to the second virtual network card eth_E on the terminal 10 via the network redirection channel. The terminal 10 uses the second virtual network card eth_E to obtain the desktop network request, thereby achieving network redirection of the cloud desktop.

In this embodiment of the present disclosure, to enhance network security, the cloud desktop server 20 further encodes the desktop network request when the desktop network request is sent through the first virtual network card eth_P to the network redirection channel, to obtain the desktop network request code. In this embodiment of the present disclosure, the specific implementation of encoding the desktop network request is not limited. Specifically, the desktop network request is encoded according to a data transmission format stipulated by the cloud desktop transmission protocol to obtain the desktop network request code. Furthermore, the desktop network request code is encrypted to obtain the desktop network request cipher-text. In this embodiment of the present disclosure, the specific implementation of encrypting the desktop network request code is not limited. In some embodiments, symmetric encryption algorithms and/or asymmetric encryption algorithms are used for encrypting the desktop network request code to obtain the desktop network request cipher-text. Thereafter, the desktop network request cipher-text is sent through the first virtual network card eth_P on the cloud desktop server 20 to the network redirection channel. Accordingly, the terminal 10 uses the second virtual network card eth_E on the terminal 10 to receive the desktop network request cipher-text from the network redirection channel. Furthermore, the terminal 10 decrypts the desktop network request cipher-text to obtain the desktop network request code. Subsequently, the desktop network request code is decoded to obtain the desktop network request. Specifically, the desktop network request code is decoded according to the data transmission format stipulated by the cloud desktop transmission protocol to obtain the desktop network request.

In this embodiment of the present disclosure, the cloud desktop server 20 redirects the desktop network request initiated by the cloud desktop server 20 to the terminal 10 through the network redirection channel between the cloud desktop server 20 and the terminal 10. Correspondingly, the terminal 10 accesses the destination address corresponding to the desktop network request. Specifically, the terminal 10 parses the destination address from the desktop network request and forwards a desktop access request to the destination address through the physical network card of the terminal 10, thereby achieving access to the destination address. For the network of the destination address, the access to the destination address by the terminal 10 is perceived, and the original source (namely the cloud desktop server 20) of the desktop network request cannot be perceived. Therefore, even for the destination network that the cloud desktop server 20 cannot access in traditional schemes, the network redirection method provided in this embodiment of the present disclosure can also achieve access to the destination network by redirecting the access to the destination network to the terminal 10, which can enrich the usage scenarios of the cloud desktop.

The request result corresponding to the desktop network request is returned from the destination address. Correspondingly, the terminal 10 obtains the request result corresponding to the desktop network request and provides the request result to the cloud desktop server 20 through the network redirection channel. Specifically, a communication path for providing the request result from the terminal 10 to the cloud desktop server 20 through the network redirection channel is a reverse path of a communication path for providing the desktop network request from the cloud desktop server 20 to the terminal 10 through the network redirection channel. For details on how the terminal 10 provides the request result to the cloud desktop server 20 through the network redirection channel, please refer to the aforementioned relevant content of how the cloud desktop server 20 provides the desktop network request to the terminal 10 through the network redirection channel, which is not further described here.

The network redirection scheme provided in this embodiment of the present disclosure establishes the network redirection channel between the cloud desktop server and the terminal according to the cloud desktop transmission protocol. Through establishing the network redirection channel between the cloud desktop server 20 and the terminal 10, the network request initiated by the cloud desktop server 20 is redirected to the terminal 10, and the terminal 10 accesses the destination address of the network request, achieving network redirection of the network request of the cloud desktop server 20. Since the network redirection channel between the cloud desktop server and the terminal in the present disclosure is established according to the cloud desktop transmission protocol, compared with the traditional network redirection scheme in FIG. 1, there is no need for dedicated network configuration, which helps to improve the efficiency of network redirection and reduce the usage threshold and the network redirection cost for cloud desktops.

On the other hand, for the network of the destination address, the access to the destination address by the terminal is perceived, and the original source (namely the cloud desktop server) of the desktop network request cannot be perceived. Therefore, even for the destination networks that the cloud desktop server cannot access in traditional schemes, the network redirection method provided in some embodiments of the present disclosure can also achieve access to the destination network by redirecting the access of the cloud desktop server to the destination network to the terminal, which can enrich the usage scenarios of the cloud desktop.

It is worth noting that the cloud desktop system provided in some embodiments of the present disclosure not only supports the above network redirection plan but also supports the plan for the cloud desktop to access the destination network in the traditional cloud desktop system. Whether to use network redirection for the desktop network request initiated by the cloud desktop server 20 is flexibly set. The following provides exemplary explanations of the optional implementation methods for setting whether the desktop network request initiated by the cloud desktop server 20 uses network redirection.

In the implementation method one provided in some embodiments, the cloud desktop management personnel independently choose whether to activate the network redirection function. The cloud desktop server 20 sets a network redirection control switch, and the management personnel control whether to activate the network redirection function by setting the state of the network redirection control switch. Correspondingly, the cloud desktop server 20 initiates a network redirection program in response to a determined operation for network redirection, and redirects the desktop network request after initiating the network redirection program to the terminal 10 through the network redirection channel. If the management personnel set the network redirection control switch to a state corresponding to closing the network redirection, the cloud desktop server 20 does not initiate the network redirection program. For the desktop network request initiated by the cloud desktop server 20 when the network redirection program is not initiated, the cloud desktop server 20 sends the desktop network request to the destination network corresponding to the desktop network request through the public network exit.

In the implementation method two provided in other embodiments, the network redirection rule is further set on the cloud desktop server 20 side. This network redirection rule is further called a network forwarding rule or a routing rule. The network redirection rule is used for setting the conditions that the desktop network request using network redirection needs to meet. The network redirection rule includes at least one of the followings: IP address range, network range, and domain name range, etc. The filtering conditions in the network redirection rule are obtained by technical personnel by combing the network traffic access requirements. Correspondingly, for the desktop network request meeting the network redirection rule, network redirection is used to access the destination network.

Based on the preset network redirection rule, the cloud desktop server 20 uses the preset network redirection rule to filter the desktop network request. If the desktop network request meets the network redirection rule, the desktop network request will be redirected to the terminal 10 through the network redirection channel.

Optionally, when the cloud desktop server 20 uses the preset network redirection rule to filter the desktop network request, the cloud desktop server 20 performs at least one of the following determination operations.

In determination operation one, it is determined whether the destination IP address of the desktop network request belongs to the preset IP address range.

In determination operation two, it is determined whether the network segment accessed by the desktop network request belongs to the preset network segment range.

In determination operation three, it is determined whether the domain name accessed by the desktop network request belongs to the preset domain name range.

In response to the determination result indicating at least one of the destination IP address of the desktop network request belonging to the preset IP address range, the network segment accessed by the desktop network request belonging to the preset network segment range, and the domain name accessed by the desktop network request belonging to the preset domain name range, it is determined that the desktop network request meets the network redirection rule. Among the above determination operations one to three, one can be implemented, or multiple can be combined. Multiple refers to two or more. For the case where multiple determination operations one to three are implemented in combination, if there is an affirmative result among the combined multiple determination operations, it is determined that the desktop network request meets the network redirection rule.

Further, the cloud desktop server 20 redirects the desktop network request meeting the network redirection rule to the terminal 10 through the network redirection channel, achieving the redirection of the network request of the cloud desktop server 20.

In addition to the above implementation embodiments of the cloud desktop system, some embodiments of the present disclosure further provide network redirection methods. The following will provide exemplary explanation of the network redirection methods provided in the some embodiments of the present disclosure from the perspectives of the cloud desktop server and the terminal.

FIG. 4 is a flowchart illustrating a network redirection method provided in some embodiments of the present disclosure. This method is adaptable to the cloud desktop server. As shown in FIG. 4, the network redirection method mainly includes the following steps.

In step 401, in response to the cloud desktop service request of the terminal, a network redirection channel is established between the cloud desktop server and the terminal according to the cloud desktop transmission protocol.

In step 402, the desktop network request is redirected from the cloud desktop server to the terminal through the network redirection channel, allowing the terminal to access the destination address corresponding to the desktop network request.

In step 403, the request result returned by the terminal is obtain from the network redirection channel for the desktop network request.

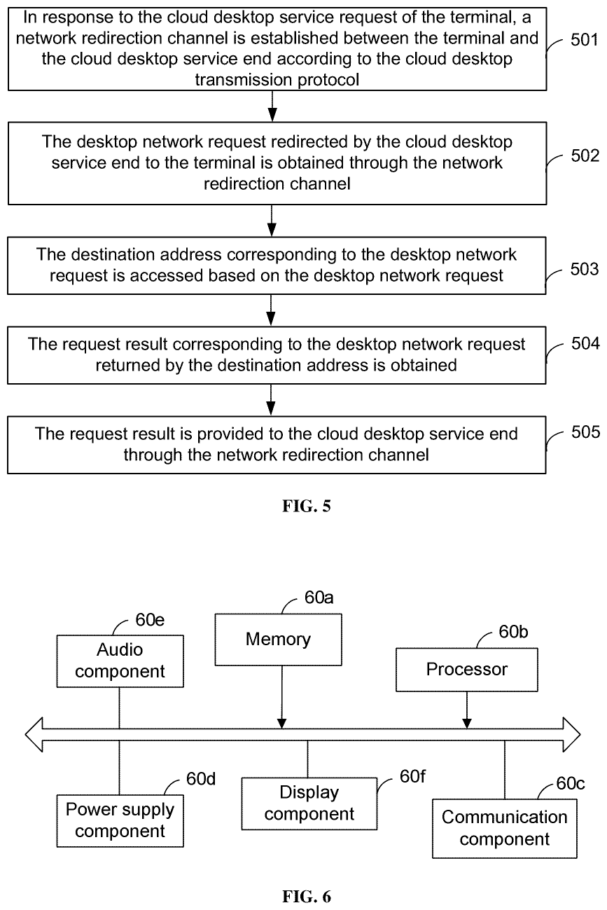

FIG. 5 is a flowchart illustrating another network redirection method provided in some embodiment of the present disclosure. This method is adaptable to the terminal. As shown in FIG. 5, the network redirection method includes the following steps.

In step 501, in response to the cloud desktop service request of the terminal, a network redirection channel is established between the terminal and the cloud desktop server according to the cloud desktop transmission protocol.

In step 502, the desktop network request redirected by the cloud desktop server to the terminal is obtained through the network redirection channel.

In step 503, the destination address corresponding to the desktop network request is accessed based on the desktop network request.

In step 504, the request result corresponding to the desktop network request returned by the destination address is obtained.

In step 505, the request result is provided to the cloud desktop server through the network redirection channel.

In this embodiment of the present disclosure, when the terminal requires the cloud desktop service, the terminal initiates the cloud desktop service request to the cloud desktop server. To achieve network redirection of the cloud desktop, the terminal and the cloud desktop server cooperate in conjunction to establish the network redirection channel between the cloud desktop server and the terminal for data transmission between the cloud desktop server and the terminal in response to the cloud desktop service request. Data forwarding is achieved between the cloud desktop server and the terminal desktop through the network redirection channel.

To achieve the establishment of a network channel between the cloud desktop server and the terminal, the cloud desktop transmission protocol is modified in this embodiment of the present disclosure to support the creation of a network channel. For a description of the cloud desktop transmission protocol, please refer to the relevant content of the system embodiment mentioned above, which is not repeated here. However, the traditional cloud desktop transmission protocol cannot be used for establishing a network channel between the cloud desktop server and the terminal. Therefore, in this embodiment of the present disclosure, the cloud desktop transmission protocol is modified to support a network channel between the cloud desktop server and the terminal. In this embodiment of the present disclosure, the network channel between the cloud desktop server and the terminal is called the network redirection channel.

Based on the above cloud desktop transmission protocol, in step 401 and step 501, the terminal and the cloud desktop server cooperate in conjunction to establish the network redirection channel between the cloud desktop server and the terminal according to the cloud desktop transmission protocol in response to the cloud desktop service request. This network redirection channel achieves network data transmission between the cloud desktop server and the terminal.

Optionally, one possible implementation of step 501 includes the following steps. In response to the cloud desktop service request, a network connection request is sent to the cloud desktop server for the cloud desktop server to establish a main channel between the cloud desktop server and the terminal in response to the network connection request. The creation strategy parameters of the network redirection channel supported by the cloud desktop transmission protocol are obtained. A network redirection channel creation request is sent, according to the creation strategy parameters of the network redirection channel, to the cloud desktop server for the cloud desktop server to establish the network redirection channel between the cloud desktop server and the terminal in the main channel in response to the network redirection channel creation request.

Accordingly, one possible implementation of step 401 includes the following steps. In response to the network connection request sent by the terminal, a main channel is established between the cloud desktop server and the terminal. The network redirection channel creation request sent by the terminal is obtained, the network redirection channel creation request being generated by the terminal based on the creation strategy parameters of the network redirection channel supported by the cloud desktop transmission protocol. In response to the network redirection channel creation request, a network redirection channel is established between the cloud desktop server and the terminal in the main channel.

In some embodiments, before the cloud desktop server establishes the network redirection channel between the cloud desktop server and the terminal according to the cloud desktop transmission protocol, the cloud desktop server authenticates the terminal based on the cloud desktop service request. Specifically, the control service of the cloud desktop server obtains the user identifier and the access password corresponding to the terminal from the cloud desktop service request. Thereafter, the cloud desktop service request is authenticated using the user identifier and the access password. For the cloud desktop service request that has passed the authentication, the terminal is allowed to access the cloud desktop server. Accordingly, one implementation of how the terminal obtains the creation strategy parameters of the network redirection channel includes the following steps. the channel creation strategy parameters corresponding to the user of the terminal are obtained from the control service of the cloud desktop server. The creation strategy parameters of the network redirection channel are obtained from the channel creation strategy parameters.

Based on the network redirection channel between the cloud desktop server and the terminal, for the desktop network request initiated by the cloud desktop server, the cloud desktop server, in step 402, redirects the desktop network request to the terminal through the network redirection channel. Specifically, the desktop network request is transmitted to the terminal through the network redirection channel to achieve the network redirection of the desktop network request initiated by the cloud desktop server. Correspondingly, in step 502, the terminal obtains the desktop network request redirected by the cloud desktop server to the terminal through the network redirection channel.

In this embodiment of the present disclosure, the network redirection channel between the cloud desktop server and the terminal is available for the transmission of desktop network request. The cloud desktop server is further necessary to have the capability to transmit desktop network request to the network redirection channel. Correspondingly, the terminal is further necessary to have the capability to receive data from the network redirection channel. Based on this, in this embodiment of the present disclosure, the cloud desktop server further creates a first virtual network card eth_P corresponding to the network redirection channel in response to the cloud desktop service request, to provide an interface for cloud desktop network access. Correspondingly, for the terminal, a second virtual network card eth_E corresponding to the network redirection channel is created on the terminal to provide an interface for proxy cloud desktop network access.

Optionally, for the cloud desktop server, the virtual network card creation commands in the operating system of the cloud desktop are called, and the virtual network card creation commands are executed to create a virtual network card on the cloud desktop server. Further, the created virtual network card is network-configured to make the virtual network correspond to the network redirection channel, thereby obtaining the first virtual network card eth_P corresponding to the network redirection channel.

Similarly, the terminal calls the virtual network card creation commands in the operating system of the terminal and executes the virtual network card creation commands to create a virtual network card on the terminal. Further, the terminal network-configures the created virtual network card to make the virtual network correspond to the network redirection channel, thereby obtaining the second virtual network card eth_E corresponding to the network redirection channel.

Based on the above first virtual network card eth_P on the cloud desktop server and the second virtual network card eth_E on the terminal 10, one implementation of step 402 includes the following steps. The desktop network request is sent through the first virtual network card eth_P to the network redirection channel, to transmit the desktop network request to the second virtual network card eth_E on the terminal 10 through the network redirection channel. For the terminal, one implementation of step 502 includes the following steps. The second virtual network card eth_E is used to obtain the desktop network request, thereby achieving network redirection of the cloud desktop.

In this embodiment of the present disclosure, to enhance network security, when the cloud desktop server sends the desktop network request through the first virtual network card eth_P to the network redirection channel, the cloud desktop server further encodes the desktop network request to obtain the desktop network request code. In this embodiment of the present disclosure, the specific implementation of encoding the desktop network request is not limited. Specifically, the desktop network request is encoded according to the data transmission format stipulated by the cloud desktop transmission protocol to obtain the desktop network request code. Furthermore, the desktop network request code is encrypted to obtain the desktop network request cipher-text. In this embodiment of the present disclosure, the specific implementation of encrypting the desktop network request code is not limited. In some embodiments, symmetric encryption algorithms and/or asymmetric encryption algorithms is used to encrypt the desktop network request code to obtain the desktop network request cipher-text. Thereafter, the desktop network request cipher-text is sent through the first virtual network card eth_P on the cloud desktop server to the network redirection channel.

Accordingly, for the terminal, the second virtual network card eth_E on the terminal is used for receiving the desktop network request cipher-text from the network redirection channel. Further, the terminal decrypts the desktop network request cipher-text to obtain the desktop network request code. Subsequently, the desktop network request code is decoded to obtain the desktop network request. Specifically, the desktop network request code is decoded according to the data transmission format stipulated by the cloud desktop transmission protocol to obtain the desktop network request.

In this embodiment of the present disclosure, the cloud desktop server redirects the desktop network request initiated by the cloud desktop server to the terminal through the network redirection channel between the cloud desktop server and the terminal. Correspondingly, in step 503, the terminal accesses the destination address corresponding to the desktop network request based on the desktop network request. Specifically, the destination address is parsed from the desktop network request; and the desktop access request is forwarded to the destination address through the physical network card of the terminal to achieve access to the destination address. For the network of the destination address, the access to the destination address by the terminal is perceived, and the original source (namely the cloud desktop server) of the desktop network request cannot be perceived. Therefore, even for the destination networks that the cloud desktop server cannot access in traditional schemes, the network redirection method provided by this embodiment of the present disclosure can also achieve access to the destination network by redirecting the access to the destination network to the terminal, which can enrich the usage scenarios of the cloud desktop.

The request result corresponding to the desktop network request is returned from the destination address. Correspondingly, in step 504, the terminal obtains the request result corresponding to the desktop network request. In step 505, the request result is provided to the cloud desktop server through the network redirection channel. Specifically, a communication path for providing the request result from the terminal to the cloud desktop server through the network redirection channel is a reverse path of a communication path for providing the desktop network request from the cloud desktop server to the terminal through the network redirection channel. Correspondingly, for the cloud desktop server, in step 403, the request result corresponding to the desktop network request is returned from the terminal through the network redirection channel. For details on how the terminal provides the request result to the cloud desktop server through the network redirection channel, please refer to the aforementioned relevant content of how the cloud desktop server provides the desktop network request to the terminal through the network redirection channel, which is not further described here.

The network redirection scheme provided in this embodiment of the present disclosure establishes the network redirection channel between the cloud desktop server and the terminal according to the cloud desktop transmission protocol. Through establishing the network redirection channel between the cloud desktop server and the terminal, the network request initiated by the cloud desktop server is redirected to the terminal, and the terminal accesses the destination address of the network request, achieving network redirection of the network request of the cloud desktop server. Since the network redirection channel between the cloud desktop server and the terminal in the present disclosure is established according to the cloud desktop transmission protocol, compared with the traditional network redirection scheme in FIG. 1, there is no need for dedicated network configuration, which helps to improve the efficiency of network redirection and reduce the usage threshold and the network redirection cost for cloud desktops.

On the other hand, for the network of the destination address, the access to the destination address by the terminal is perceived, and the original source (namely the cloud desktop server) of the desktop network request cannot be perceived. Therefore, even for the destination networks that the cloud desktop server cannot access in traditional schemes, the network redirection method provided in this embodiment of the present disclosure can also achieve access to the destination network by redirecting the access of the cloud desktop server to the destination network to the terminal, which can enrich the usage scenarios of the cloud desktop.

It is worth noting that in addition to the above network redirection plan, the cloud desktop system provided in this embodiment of the present disclosure can also support the plan for the cloud desktop to access the destination network in the traditional cloud desktop system. Whether to use network redirection for the desktop network request initiated by the cloud desktop server is flexibly set. The following provides exemplary explanations of the optional implementation methods for setting whether the desktop network request initiated by the cloud desktop server uses network redirection.

In the implementation method one provided in some embodiments, the cloud desktop management personnel independently chooses whether to activate the network redirection function. The cloud desktop server sets a network redirection control switch, and the management personnel control whether to activate the network redirection function by setting the state of the network redirection control switch. Correspondingly, the cloud desktop server initiates a network redirection program in response to a determined operation for network redirection, and redirects the desktop network request after initiating the network redirection program to the terminal through the network redirection channel. If the management personnel set the network redirection control switch to a state corresponding to closing the network redirection, the cloud desktop server does not initiate the network redirection program. For the desktop network request initiated by the cloud desktop server when the network redirection program is not initiated, the cloud desktop server sends the desktop network request to the destination network corresponding to the desktop network request through the public network exit.

In the implementation method two provided in other embodiments, the network redirection rule is further set on the cloud desktop server side. This network redirection rule is further called a network forwarding rule or a routing rule. The network redirection rule is used for setting the conditions that the desktop network request using network redirection needs to meet. The network redirection rule includes at least one of the followings: IP address range, network range, and/or domain name range, etc. The filtering conditions in the network redirection rule are obtained by technical personnel by combing the network traffic access requirements. Correspondingly, for the desktop network request meeting the network redirection rule, network redirection is used to access the destination network.

Based on the preset network redirection rule, the cloud desktop server uses the preset network redirection rule to filter the desktop network request. If the desktop network request meets the network redirection rule, the desktop network request will be redirected to the terminal through the network redirection channel.

Optionally, when the cloud desktop server uses preset network redirection rule to filter the desktop network request, the cloud desktop server performs at least one of the following determination operations.

In determination operation one, it is determined whether the destination IP address of the desktop network request belongs to the preset IP address range.

In determination operation two, it is determined whether the network segment accessed by the desktop network request belongs to the preset network segment range.

In determination operation three, it is determined whether the domain name accessed by the desktop network request belongs to the preset domain name range.

In response to the determination result indicating at least one of the destination IP address of the desktop network request belonging to the preset IP address range, the network segment accessed by the desktop network request belonging to the preset network segment range, and the domain name accessed by the desktop network request belonging to the preset domain name range, it is determined that the desktop network request meets the network redirection rule. Among the above determination operations one to three, one can be implemented, or multiple can be combined. Multiple refers to two or more. For the case where multiple determination operations one to three are implemented in combination, if there is an affirmative result among the combined multiple determination operations, it is determined that the desktop network request meets the network redirection rule.

Further, the cloud desktop server redirects the desktop network request meeting the network redirection rule to the terminal through the network redirection channel, achieving the redirection of the network request of the cloud desktop server.

It should be noted that in the aforementioned embodiments, each step of the provided method can be executed by the same device, or the method can also be executed by different devices as the executing entity. For instance, an executed object for steps 401 and 402 is Device A. Alternatively, the executed object for step 401 is Device A, and the executed object for step 402 is Device B, and so on.

Additionally, some of the processes described in the aforementioned embodiments and drawings include multiple operations that appear in a specific order. However, it should be clearly understood that these operations can be executed in an order other than that in which these operations appear in this text or can be executed in parallel. The operation numbers, such as 401, 402, etc., are used for distinguishing different operations and do not represent any execution order. Moreover, these processes can include more or fewer operations, and these operations can be executed in order or in parallel.

Accordingly, the some embodiments of the present disclosure further provide a computer-readable storage medium storing computer instructions. When the computer instructions are executed by at least one processor, the at least one processor is caused to perform the steps in the aforementioned network redirection method.

FIG. 6 is a structural schematic diagram of a computing device provided in some embodiments of the present disclosure. As shown in FIG. 6, the computing device includes: a memory 60a, a processor 60b, and a communication component 60c. The memory 60a is arranged for storing computer programs.

In some embodiments, the computing device is implemented as a server device, arranged for providing cloud desktop services. Accordingly, the processor 60b is coupled with the memory 60a and the communication component 60c, and is arranged for executing computer programs which includes that: in response to the cloud desktop service request of the terminal, a network redirection channel is established between the cloud desktop server and the terminal according to the cloud desktop transmission protocol; the communication component 60c is used to redirect the desktop network request from the cloud desktop server to the terminal through the network redirection channel, allowing the terminal to access the destination address corresponding to the desktop network request; the request result returned by the terminal is obtained through the communication component 60c from the network redirection channel.

In some embodiments, the processor 60b is arranged for, in response to the cloud desktop service request of the terminal, establishing the network redirection channel between the cloud desktop server and the terminal according to the cloud desktop transmission protocol. Specifically, in response to the network connection request sent by the terminal, the processor 60b establishes a main channel between the cloud desktop server and the terminal, and obtains the network redirection channel creation request sent by the terminal through the communication component 60c, the network redirection channel creation request being generated by the terminal based on the creation policy parameters of the network redirection channel supported by the cloud desktop transmission protocol. In response to the network redirection channel creation request, the processor 60b establishes the network redirection channel between the cloud desktop server and the terminal in the main channel.

Optionally, the processor 60b is further arranged for: authenticating the terminal according to the cloud desktop service request and allowing the terminal to access the cloud desktop server to obtain the creation policy parameters of the network redirection channel from the cloud desktop server when the terminal passes the authentication.

Optionally, the processor 60b is further arranged for: creating a first virtual network card corresponding to the network redirection channel on the cloud desktop server in response to the cloud desktop service request, to provide an interface for cloud desktop network access. When the processor 60b redirects the desktop network request from the cloud desktop server to the terminal through the network redirection channel, the processor 60b is further arranged for: sending the desktop network request through the first virtual network card to the network redirection channel via the communication component 60c, to transmit the desktop network request to the second virtual network card of the terminal through the network redirection channel, and allowing the terminal to obtain the desktop network request through the second virtual network card, the second virtual network card being the virtual network card created by the terminal corresponding to the network redirection channel.

Optionally, when the processor 60b sends the desktop network request to the network redirection channel through the first virtual network card, the processor 60b is further arranged for: encoding the desktop network request to obtain the desktop network request code; encrypting the desktop network request code to obtain the desktop network request cipher-text; and sending the desktop network request cipher-text to the network redirection channel through the first virtual network card.

Optionally, the processor 60b is further arranged for: before redirecting the desktop network request from the cloud desktop server to the terminal through the network redirection channel, in response to a determined operation for network redirection, initiating a network redirection program; and redirecting the desktop network request after initiating the network redirection program to the terminal; and/or, filtering the desktop network request using preset network redirection rule; and if the desktop network request meets the network redirection rule, redirecting the desktop network request to the terminal through the network redirection channel.

In other embodiments of present disclosure, the computing device is implemented as a terminal device, acting as a client for the cloud desktop. Accordingly, the processor 60b is further arranged for: in response to the cloud desktop service request of the terminal, establishing the network redirection channel between the terminal and the cloud desktop server according to the cloud desktop transmission protocol; obtaining the desktop network request redirected by the cloud desktop server to the terminal through the communication component 60c via the network redirection channel; accessing the destination address corresponding to the desktop network request; obtaining the request result corresponding to the desktop network request returned by the destination address; and providing the request result to the cloud desktop server through the communication component 60c via the network redirection channel.

Optionally, in response to the cloud desktop service request of the terminal, when the network redirection channel between the terminal and the cloud desktop server is established according to the cloud desktop transmission protocol, the processor 60b is further arranged for: in response to the cloud desktop service request, initiating the network connection request to the cloud desktop server via the communication component 60c, to allow the cloud desktop server to establish a main channel between the cloud desktop server and the terminal in response to the network connection request; obtaining the creation strategy parameters of the network redirection channel supported by the cloud desktop transmission protocol; and, according to the creation strategy parameters of the network redirection channel, initiating a network redirection channel creation request to the cloud desktop server via the communication component 60c, to allow the cloud desktop server to establish the network redirection channel between the cloud desktop server and the terminal in the main channel in response to the network redirection channel creation request.

Optionally, the processor 60b is further arranged for: creating a second virtual network card corresponding to the network redirection channel on the terminal to provide an interface for proxy cloud desktop network access. Accordingly, when the processor 60b obtains the desktop network request redirected by the cloud desktop server to the terminal through the network redirection channel, the processor 60b is further arranged for: using the second virtual network card to obtain the desktop network request from the network redirection channel.

Specifically, when the processor 60b uses the second virtual network card to obtain the desktop network request from the network redirection channel, the processor 60b is further arranged for: receiving the desktop network request cipher-text from the network redirection channel via the second virtual network card, the desktop network request cipher-text being obtained by encrypting, by the cloud desktop server, the desktop network request code corresponding to the desktop network request; decrypting the desktop network request cipher-text to obtain the desktop network request code, the desktop network request code is obtained by encoding, by the cloud desktop server, the desktop network request; and decoding the desktop network request code to obtain the desktop network request.

Optionally, when the processor 60b accesses the destination address corresponding to the desktop network request, the processor 60b is further arranged for: parsing the destination address from the desktop network request; and forwarding the desktop network request to the destination address via the physical network card of the terminal.

In some optional implementation modes, as shown in FIG. 6, the computing device further includes optional components such as a power supply component 60d. In some embodiments, the computing device is implemented as terminal devices such as computers, mobile phones, etc. Accordingly, the computing device further includes components such as an audio component 60e, a display component 60f, etc. FIG. 6 schematically shows some components, which does not mean that the computing device already contains all the components shown in FIG. 6, nor does it mean that the computing device cannot include the components not shown in FIG. 6.

The computing device provided in this embodiment can establish the network redirection channel between the cloud desktop server and the terminal according to the cloud desktop transmission protocol, and through establishing the network redirection channel between the cloud desktop server and the terminal, redirect the network request initiated by the cloud desktop server to the terminal, and access the destination address of the network request through the terminal, achieving network redirection of the network request from the cloud desktop server. Since the network redirection channel between the cloud desktop server and the terminal in present disclosure is established according to the cloud desktop transmission protocol, it does not require dedicated network configuration compared with traditional network redirection schemes, which helps to improve the efficiency of network redirection and reduce the usage threshold and the network redirection cost of cloud desktops.

On the other hand, for the network of the destination address, the access to the destination address by the terminal is perceived, and the original source (namely the cloud desktop server) of the desktop network request cannot be perceived. Therefore, even for the destination networks that the cloud desktop server cannot access in traditional schemes, the network redirection method provided in this embodiment of the present disclosure can also achieve access to the destination network by redirecting the access of the cloud desktop server to the destination network to the terminal, which can enrich the usage scenarios of the cloud desktop.

In this embodiment of the present disclosure, the memory is arranged for storing computer programs and storing various other data to support operations on the device in which the memory is located. The processor is arranged for executing the computer programs stored in the memory to implement the corresponding control logic. The memory is implemented by any type of transitory or non-transitory storage device or a combination of the transitory device and the non-transitory storage device, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, disk, or optical disc.

In this embodiment of the present disclosure, the processor is any hardware processing device capable of executing the method logic described above. Optionally, the processor is a Central Processing Unit (CPU), Graphics Processing Unit (GPU), or Microcontroller Unit (MCU); the processor is further a Field-Programmable Gate Array (FPGA), Programmable Array Logic (PAL), General Array Logic (GAL), Complex Programmable Logic Device (CPLD), or other programmable devices; or the processor is further an Advanced RISC Machines (ARM) processor or a System on Chip (SOC), among others, but not limited to these.

In this embodiment of the present disclosure, the communication component is arranged for facilitating wired or wireless communication between the device in which the communication component is located and other devices. The device with the communication component accesses wireless networks based on communication standards, such as Wireless Fidelity (WiFi), 2G or 3G, 4G, 5G, or a combination thereof. In an exemplary implementation, the communication component is arranged for receiving broadcast signals or broadcast-related information from an external broadcast management system via a broadcast channel. In another exemplary implementation, the communication component is further implemented based on Near Field Communication (NFC) technology, Radio Frequency Identification (RFID) technology, Infrared Data Association (IrDA) technology, Ultra-Wideband (UWB) technology, Bluetooth (BT) technology, or other technologies.

In this embodiment of the present disclosure, the display component includes a Liquid Crystal Display (LCD) and a touch panel (TP). If the display component includes a touch panel, the display component is implemented as a touch screen to receive input signals from the user. The touch panel includes at least one touch sensor to detect touch, swipe, and gestures on the touch panel. The at least one touch sensor detects not only the boundaries of touch or swipe actions but also the duration and pressure associated with the touch or swipe operations.

In this embodiment of the present disclosure, the power component is arranged for providing electricity to various components of the device in which the power component is located. The power component includes a power management system, at least one power source, and other components associated with generating, managing, and distributing electricity for the device.

In this embodiment of the present disclosure, the audio component is arranged for outputting and/or inputting audio signals. For example, the audio component includes a microphone (MIC), which is arranged for receiving external audio signals when the device is in operation modes such as call mode, recording mode, and voice recognition mode. The received audio signals are further stored in the memory or sent via the communication component. In some implementations, the audio component further includes a speaker for outputting audio signals. For example, for devices with voice interaction capabilities, voice interaction with the user is implemented through the audio component.

It should be noted that the terms “first”, “second” and so on, used in this text are to distinguish between different messages, devices, modules, etc., and do not represent a sequence order or limit “first” and “second” to being different types.

Those skilled in the art should understand that the embodiments of the present disclosure can be provided as methods, systems, or computer program products. Therefore, the present disclosure can take the form of a purely hardware implementation, a purely software implementation, or an implementation combining software and hardware. Moreover, the present disclosure can take the form of a computer program product implemented on at least one computer-readable storage medium containing computer-executable program code (including but not limited to disk storage, CD-ROM, optical memory, etc.).

The present disclosure is described with reference to flowcharts and/or block diagrams of methods, devices (systems), and computer program products in accordance with embodiments of present disclosure. It should be understood that each process and/or block, as well as combinations of processes and/or blocks in the flowcharts and/or block diagrams, can be implemented by computer program instructions. These computer program instructions can be provided to a general-purpose computer, a special-purpose computer, an embedded processor, or other programmable data processing devices to produce a machine that achieves the function(s) specified in at least one process and/or block of a flowchart and/or block diagram by executing instructions via a processor of a computer or other programmable data processing device.

These computer program instructions may also be stored in a computer-readable memory that directs a computer or other programmable data processing device to work in a specific manner, so that the instructions stored in the computer-readable memory produce a manufacturing product including an instruction device, which achieves the functions specified in at least one process and/or block of a flowchart and/or block diagram.

These computer program instructions may also be loaded onto a computer or other programmable data processing device, so as to execute a series of operational steps on the computer or other programmable device to produce a computer-implemented processing, thereby providing steps to achieve the functions specified in at least one process and/or block of a flowchart and/or block diagram.

In a typical configuration, a computing device includes at least one processor (CPU), input/output interface, network interface, and memory.

Memory may include non-permanent storage in the form of computer-readable media, such as Random Access Memory (RAM) and/or non-transitory memory, such as Read-Only Memory (ROM) or flash RAM. Memory is an example of computer-readable media.

The storage medium of a computer is computer-readable media, also known as readable media. Readable media include both permanent and non-permanent, removable and non-removable media, implemented by any method or technology for information storage. Information includes computer-readable instructions, data structures, program modules, or other data. Embodiments of computer storage medium include, but are not limited to, Phase-Change Random Access Memory (PRAM), Static Random Access Memory (SRAM), Dynamic Random Access Memory (DRAM), other types of random access memory (RAM), Read-Only Memory (ROM), Electrically Erasable Programmable Read-Only Memory (EEPROM), flash memory, or other memory technologies, Read-Only Disc-Read-Only Memory (CD-ROM), Digital Versatile Disc (DVD) or other optical storage, magnetic tape cartridges, disk storage, or other magnetic storage devices, or any other non-transitory media, which can be used to store information accessible by a computing device. As defined herein, computer-readable media does not include transitory computer-readable media, such as modulated data signals and carriers.

It should also be noted that the terms “including”, “contain”, or any other variant are intended to encompass a non-exclusive inclusion, so that a process, method, product, or device that includes a list of elements not only includes those elements but also includes other elements that are not expressly listed, or includes elements inherent to such a process, method, product, or device. In the absence of further limitations, an element qualified by the phrase “including a . . . ” does not exclude the existence of additional such elements in the process, method, product, or device that includes the specified element.

The above description is illustrative of the present disclosure and is not intended to limit the present disclosure. For those skilled in the art, the present disclosure may be subject to various modifications and variations. Any modifications, equivalent substitutions, improvements, etc., made within the spirit and principle of the present disclosure should be included within the scope of the claims of the present disclosure.

1. A cloud desktop system, comprising: a terminal and a cloud desktop server;
the terminal, arranged for sending a cloud desktop service request to the cloud desktop server;
the cloud desktop server cooperated in conjunction with the terminal, arranged for, in response to the cloud desktop service request, establishing a network redirection channel between the cloud desktop server and the terminal according to a cloud desktop transmission protocol, the cloud desktop transmission protocol supporting the establishment of the network redirection channel;
the cloud desktop server, further arranged for redirecting a desktop network request of the cloud desktop server to the terminal through the network redirection channel;
the terminal, further arranged for accessing a destination address corresponding to the desktop network request and providing a request result of the desktop network request returned from the destination address to the cloud desktop server through the network redirection channel.

2. The system as claimed in claim 1, wherein when the terminal and the cloud desktop server establishing the network redirection channel between the cloud desktop server and the terminal according to the cloud desktop transmission protocol, the terminal is further arranged for, in response to the cloud desktop service request, sending a network connection request to the cloud desktop server; the cloud desktop server is further arranged for, in response to the network connection request, establishing a primary channel between the cloud desktop server and the terminal; the terminal is further arranged for obtaining creation policy parameters of the network redirection channel supported by the cloud desktop transmission protocol, and sending a network redirection channel creation request to the cloud desktop server according to the creation policy parameters of the network redirection channel; the cloud desktop server is further arranged for, in response to the network redirection channel creation request, establishing the network redirection channel between the cloud desktop server and the terminal in the primary channel.

3. The system as claimed in claim 1, wherein the cloud desktop server is further arranged for, in response to the cloud desktop service request, creating a first virtual network card corresponding to the network redirection channel on the cloud desktop server to provide an interface for cloud desktop network access; the terminal is further arranged for creating a second virtual network card corresponding to the network redirection channel on the terminal to provide an interface for proxy cloud desktop network access.

4. A network redirection method, comprising:
in response to a cloud desktop service request of a terminal, establishing a network redirection channel between a cloud desktop server and the terminal according to a cloud desktop transmission protocol;
redirecting a desktop network request of the cloud desktop server to the terminal through the network redirection channel for the terminal to access a destination address corresponding to the desktop network request;
obtaining a request result of the desktop network request returned by the terminal through the network redirection channel.

5. The method as claimed in claim 4, wherein, in response to the cloud desktop service request of the terminal, establishing the network redirection channel between the cloud desktop server and the terminal according to the cloud desktop transmission protocol comprises:
in response to a network connection request sent by the terminal, establishing a primary channel between the cloud desktop server and the terminal;
obtaining a network redirection channel creation request sent by the terminal, the network redirection channel creation request being generated by the terminal based on creation policy parameters of the network redirection channel supported by the cloud desktop transmission protocol;
in response to the network redirection channel creation request, establishing the network redirection channel between the cloud desktop server and the terminal in the primary channel.

6. The method as claimed in claim wherein the method further comprises:
in response to the cloud desktop service request, creating a first virtual network card corresponding to the network redirection channel on the cloud desktop server to provide an interface for cloud desktop network access;
redirecting the desktop network request of the cloud desktop server to the terminal through the network redirection channel for the terminal to access the destination address corresponding to the desktop network request comprises:
sending the desktop network request to the network redirection channel through the first virtual network card to transmit the desktop network request to a second virtual network card of the terminal through the network redirection channel for the terminal to obtain the desktop network request through the second virtual network card, the second virtual network card being a virtual network card corresponding to the network redirection channel created by the terminal.

7. The method as claimed in claim 6, wherein sending the desktop network request to the network redirection channel through the first virtual network card comprises:
encoding the desktop network request to obtain a desktop network request code;
encrypting the desktop network request code to obtain a desktop network request cipher-text;
sending the desktop network request cipher-text to the network redirection channel through the first virtual network card.

8. The method as claimed in claim 4, wherein the method further comprises:
before redirecting the desktop network request of the cloud desktop server to the terminal through the network redirection channel, in response to a determination operation for network redirection, initiating a network redirection program, and redirecting a desktop network request after the initiation of the network redirection program to the terminal.

9. A network redirection method, comprising:
in response to a cloud desktop service request of a terminal, establishing a network redirection channel between the terminal and a cloud desktop server according to a cloud desktop transmission protocol;
obtaining a desktop network request redirected by the cloud desktop server to the terminal through the network redirection channel;
accessing a destination address corresponding to the desktop network request according to the desktop network request;
obtaining a request result returned from the destination address in response to the desktop network request;
providing the request result to the cloud desktop server through the network redirection channel.

10. The method as claimed in claim 9, wherein, in response to the cloud desktop service request of the terminal, establishing the network redirection channel between the terminal and the cloud desktop server according to the cloud desktop transmission protocol comprises:
in response to the cloud desktop service request, sending a network connection request to the cloud desktop server for the cloud desktop server to establish a primary channel between the cloud desktop server and the terminal in response to the network connection request;
obtaining creation policy parameters of the network redirection channel supported by the cloud desktop transmission protocol;
sending, according to the creation policy parameters of the network redirection channel, a network redirection channel creation request to the cloud desktop server for the cloud desktop server to, in response to the network redirection channel creation request, establish the network redirection channel between the cloud desktop server and the terminal in the primary channel.

11. The method as claimed in claim 9, wherein the method further comprises:
creating a second virtual network card corresponding to the network redirection channel on the terminal to provide an interface for proxy cloud desktop network access;
obtaining the desktop network request redirected by the cloud desktop server to the terminal through the network redirection channel comprises:
obtaining the desktop network request from the network redirection channel using the second virtual network card.

12. The method as claimed in claim 11, wherein obtaining the desktop network request from the network redirection channel using the second virtual network card comprises:
receiving a desktop network request cipher-text from the network redirection channel using the second virtual network card, the desktop network request cipher-text being encrypted by the cloud desktop server based on a desktop network request code corresponding to the desktop network request;
decrypting the desktop network request cipher-text to obtain the desktop network request code, the desktop network request code being obtained by the cloud desktop server encoding the desktop network request;
decoding the desktop network request code to obtain the desktop network request.

13. (canceled)

14. (canceled)

15. The method as claimed in claim 4, wherein the method further comprises:
filtering the desktop network request using a preset network redirection rule; and in response to the desktop network request meeting the preset network redirection rule, redirecting the desktop network request to the terminal through the network redirection channel.

16. The method as claimed in claim 5, wherein the main channel between the cloud desktop server and the terminal is a Transmission Control Protocol connection.

17. The method as claimed in claim 5, wherein the main channel between the cloud desktop server and the terminal supports various data transmission sub-channels defined by the cloud desktop transmission protocol.

18. The method as claimed in claim 17, wherein the various data transmission sub-channels comprise: Universal Serial Bus channels, video channels, display channels, and network redirection channels.

19. The method as claimed in claim 5, wherein creation strategy parameters of the sub-channels are the same as creation strategy parameters of the main channel.

20. The method as claimed in claim 5, wherein the creation strategy parameters of the sub-channels or the main channel comprise: image quality information, peripheral redirection strategy and network redirection strategy of the terminal.

21. The method as claimed in claim 4, wherein before establishing the network redirection channel between the cloud desktop server and the terminal according to the cloud desktop transmission protocol, the method further comprises:
obtaining a user identifier and an access password corresponding to the terminal from the cloud desktop service request;
authenticating the cloud desktop service request according to the user identifier and the access password.

22. The method as claimed in claim 15, wherein filtering the desktop network request using the preset network redirection rule comprises at least one of the followings:
determining whether a destination address of the desktop network request belongs to a preset address range;
determining whether a network segment accessed by the desktop network request belongs to a preset network segment range;
determining whether a domain name accessed by the desktop network request belongs to a preset domain name range.
